(19) United States
(12) Patent Application Publication
(10) Pub. No.: US 2005/0273978 A1
(43) Pub. Date: Dec. 15, 2005

(54) Friction Hinge System

(76) Inventor: Thomas J. Norman JR., Richardson, TX (US)

Correspondence Address: LAURA N. TUNNELL, P.O. BOX 91929, SANTA BARBARA, CA, 93190, US

(21) Appl. No.: 11/160,172

(22) Filed: Jun. 12, 2005

Related U.S. Application Data
(60) Provisional application No. 60/521,665, filed on Jun. 15, 2004.

(51) Int. Cl. E05D 11/00

(52) U.S. Cl. 16/342

(57) ABSTRACT

Means to create a friction restraint between the interlocking leaves of a hinge. The outer surface of the hinge pin shaft is in contact with the inner surface of the interlocking elements. Friction is generated between the contacting surfaces through a motion resistive material comprising the outside surface of the hinge pin shaft, the inner surface of the knuckle, or both.

A barrel, or butt hinge is a hinge composed of interlocking plates attached to abutting surfaces of fixed and moveable elements, the fixed element having an opening which can be covered by the moveable element, such as a door and a door jam. The interlocking plates have curved leaves that wrap around a common pin. The barrel hinge is one of the most common types of door attachments employed in modern building construction.

### BACKGROUND AND PRIOR ART

Vertical doors are generally installed with two or more independent hinge assemblies. The hinge assemblies perform two functions; bearing weight and providing an axis of rotation to enable opening and closing the door. Ideally, this axis of rotation parallels the direction of the gravitational force acting on the mass of the door. However, the center of mass of the door is physically offset from the axis of rotation. In addition, the hinge assemblies may be slightly misaligned at initial installation or become so over time due to a shifting door jam. The net effect of even slight misalignments or unbalanced tension between hinge assemblies often results in unintended and undesirable door movement.

U.S. Pat. No. 6,574,836 B1 addresses this problem by providing an adjustable lateral force to the exterior knuckles of a barrel type door hinge. While the '836 patent indeed provides an external force resistant to unintended door movement, it requires the installation of an external visible device. The '836 patent operates by applying resistance to the outside surface of adjoining knuckles on separate leaves. The resistance is applied by means of a series of “brake pads”, the placement of which is dependent on the particular geometry of a given hinge model. Moreover, the '836 device will move slightly with each opening and closing of the door, requiring routine maintenance and potentially interfering with its range of motion.

It is an objective of this invention to provide a simple, inexpensive internal friction restraint for a hinge that will function with a hinge of any length, width or leaf configuration.

It is an objective of this invention to provide a simple, inexpensive internal friction restraint for a hinge that can be installed with a minimum of effort and require only basic tools.

It is an objective of this invention to provide a simple, inexpensive internal friction restraint for a hinge that is easily manufactured.

It is an objective of this invention to provide a simple, inexpensive internal friction restraint for a hinge that is visibly innocuous and requires minimal change to existing hardware.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### SUMMARY

An internal friction system for a typical hinge is described wherein friction is created at the contacting surface between the hinge pin and the leaf knuckle. Either or both of the inside surface of the leaf knuckle or the outside surface of the hinge pin shaft can be covered with a motion resistive material. The system can be either adjustable or non-adjustable. The system can further be either removeable or non-removeable.

### DESCRIPTION OF THE PREFERRED EMBODIMENTS

The definitions below serve to provide a clear and consistent understanding of the specification and claims, including the scope given to such terms.

Hinge Pin—Rod running the length of the hinge, holding the leaves together.

Leaf—the portion of a hinge extending laterally from the knuckle

Knuckle—the hollow circular part at the joint of a hinge through which a pin is passed.

Motion resistive material—substance amenable to creating friction upon contact with another surface.

### BRIEF DESCRIPTION OF THE DRAWINGS

FIG. 1 is an illustration of a typical hinge assembly.

FIG. 2 is an illustration of a typical hinge pin.

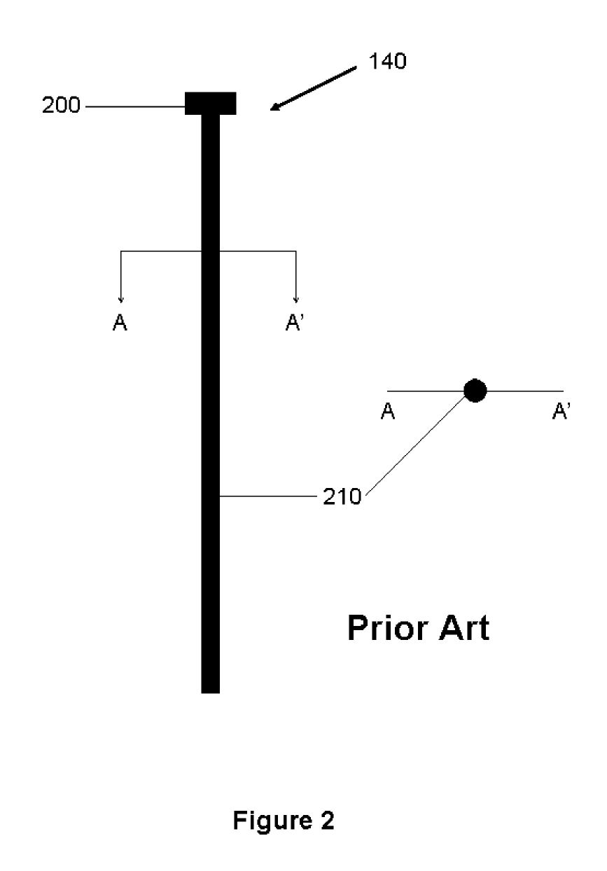

FIG. 3 illustrates the basic features of the expandable hinge pin embodiment of the present disclosure.

FIG. 4 illustrates the non-expandable hinge pin embodiment of the present disclosure.

### IDENTIFICATION OF NUMBERS USED IN THE DRAWINGS

100—typical hinge assembly

110—leaves of hinge

120—knuckles

130—cylindrical void of knuckle through which pin is inserted

140—standard hinge pin

200—head of standard hinge pin

210—hinge pin shaft

300—adjustable hinge pin of the present invention

310—hinge pin head

320—hinge pin end assembly

330—hinge pin core

340—expandable sleeve comprised of motion resistive material surrounding hinge pin core

400—non-adjustable hinge pin of the present invention

410—hinge pin head

430—hinge pin core

440—motion resistive material surrounding hinge pin core

### DETAILED DESCRIPTION OF THE PREFERRED EMBODIMENTS

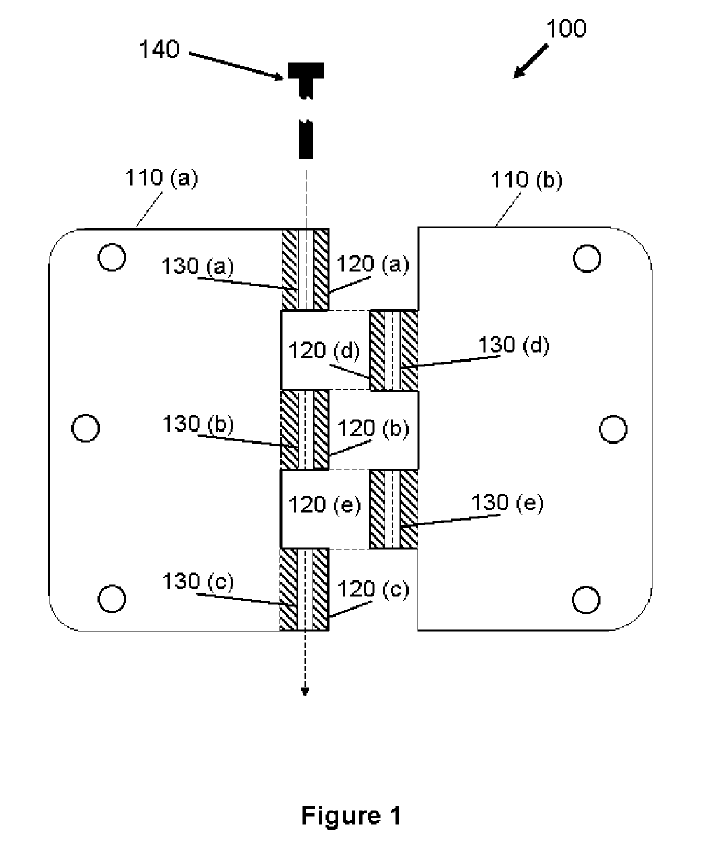

A typical door hinge (100) is shown in FIG. 1. It has two leaves (110), one of which is attached to a moveable structure such as a door and the other attached to a fixed structure such as door jam, but may also be used when both leaves are mounted on a movable structure, such as on multi-panel shutters.

The leaves have two or more interlocking knuckles (120) with a cylindrical void (130) in common alignment with each. A hinge pin shaft (210) fits snugly within the cylindrical void of each knuckle (130) so as to connect the two leaves of the hinge together while allowing rotational movement about the hinge pin axis. The pin commonly has a head (200) to prevent the pin from sliding through the knuckle (130),

Two general embodiments are described in this disclosure. A removable hinge pin with an optionally expandable radius is described as well as a non-removable pin included as part of a pre-built hinge assembly. The non-removable pin may be inserted as a replacement pin in a pre-installed hinge.

In the first embodiment, the standard hinge pin (140) is replaced by a pin with an expandable radius (300) in order to create an adjustable friction coupling between the leaves (110) of the hinge. The expandable pin may be used on one or more the hinges of the door, depending on the restraining force desired. The weight of the door may dictate that the expandable hinge pin be part of a supplemental hinge as a non weight-bearing assembly.

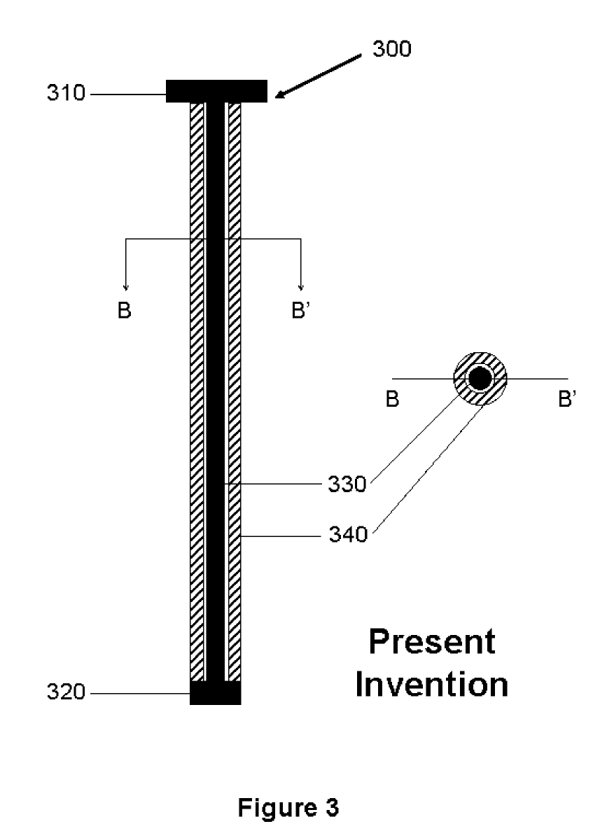

The expandable pin (300), shown in FIG. 3, consists of a shaft (330), an expandable sleeve (340), and constraining members (310) and (320) on the ends of the shaft. The constraining members act to snugly contain the expandable sleeve (340) by applying pressure on the ends. A simple machine screw, a lock nut and Tygon® tubing, for example, can perform the basic functions of the expandable sleeve and constraining members.

One or both of the constraining members (310) and (320) are optionally movable along the length of the shaft (330). When one or both are moved in such a way as to shorten the distance between them, the expandable sleeve is squeezed at both ends by the constraining members and becomes distorted in the radial direction. Effectively, the sleeve bows out in the mid-shaft region, thereby increasing its radius and providing an increased amount of friction between the outer surface of the sleeve (340) and the inner wall defining the cylindrical void (130) running through each knuckle of its leaf.

The expandable sleeve may be of a variety of composite elastic materials such as rubber, silicon rubber, or polyurethane. For the pin to be removable, the material must have an elastic hysteresis such that it will not cold flow or take a “set” under pressure. When the compression force is relieved, the sleeve must be able to return to its approximate original diameter in order to facilitate removal.

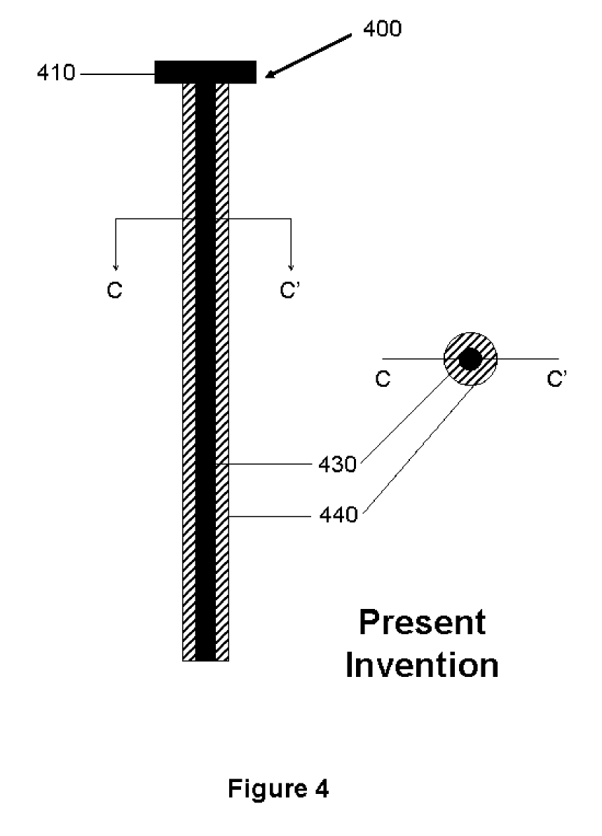

A second embodiment of the friction hinge pin is appropriate for a pre-built assembly. Such a configuration would include a set of leaves with the standard hinge pin replaced by a non-removable pin made of a motion resistive material such as natural rubber, silicon rubber, or a coated metal pin as shown in FIG. 4, capable of creating friction upon contact with the inner surface of the knuckles. Such an embodiment allows the use of a hinge pin having the standard shape and size. The leaves of such an assembly could be made much thinner and smaller than standard leaves so as to render mortising unnecessary if installed at a non-weight bearing location. A coated pin may also be field insertable as a replacement for a standard metal pin.

A variation of the second embodiment, also appropriate for a pre-built assembly, involves using a standard hinge pin in combination with a set of leaves, wherein the inside surface of the leaf knuckles are coated with a motion resistive material.

1. A hinge system capable of creating friction between a hinge pin and the interior surface of a leaf knuckle, said hinge system comprising:
a leaf knuckle, said leaf knuckle having an inner surface,
a hinge pin, said hinge pin capable of being inserted into said leaf knuckle, said hinge pin further having a shaft, said shaft having an outer surface,
a contact interface between said outer surface of said shaft and said inner surface of said knuckle,
wherein at least one of said inner surface of said leaf knuckle and said outer surface of said shaft is covered with a motion resistive material.

2. A hinge system as in claim 1 wherein said inner surface of said leaf knuckle is covered with a motion resistive material.

3. A hinge system as in claim 1 wherein said outer surface of said shaft of said hinge pin is covered with a motion resistive material.

4. A hinge system as in claim 1 wherein said hinge pin is adjustable.

5. A hinge pin as in claim 4 comprising a shaft, two end constraining members, and a flexible cylindrical sleeve, wherein said shaft has a length, said shaft is insertable into said cylindrical sleeve, said cylindrical sleeve has a length, said length of said cylindrical sleeve is equal to or shorter than said length of said shaft, and at least one of said two end constraining members is movable along said length of said shaft.

6. A hinge pin as claimed in claim 5, wherein said shaft comprises a rod, said rod having at least one threaded end, wherein said at least one of said two end constraining members is internally threaded so as to be mateable with said at least one threaded end of said rod.
